(19) United States
(12) Patent Application Publication
(10) Pub. No.: US 2003/0123850 A1
(43) Pub. Date: Jul. 3, 2003

(54) Intelligent news video browsing system and method thereof

(75) Inventors: Sung Bae Jun, Seoul (KR); Kyoung Ro Yoon, Seoul (KR)

Correspondence Address: LEE & HONG, 801 SOUTH FIQUEROA STREET, 14TH FLOOR, LOS ANGELES, CA, 90017, US

(73) Assignee: LG Electronics Inc.

(21) Appl. No.: 10/263,045

(22) Filed: Oct. 1, 2002

(30) Foreign Application Priority Data
Dec. 28, 2001 (KR) 87073/2001

(51) Int. Cl. H04N 5/783

(52) U.S. Cl. 386/68; 386/95; 386/70

(57) ABSTRACT

Disclosed herein is a method allowing a user to browse news video more conveniently. An intelligent news video browsing method according to the present invention comprises the steps of: producing index information on anchor shot segment and episode scene segment in news video contents including at least both of the segments; and browsing a concerned news video by applying different reproduction methods and different reproduction speeds to each of the anchor shot segment and episode scene segment in the news video contents.

### BACKGROUND OF THE INVENTION

1. Field of the Invention

The present invention relates to a fast search method for a moving picture, and more particularly to a news video browsing system and method that is capable of conveniently browsing news by using a characteristic of news video.

2. Description of the Related Art

With the development of mass media and the facilitation of creation of multimedia contents, the general public can access to a huge amount of media.

So, as the amount of multimedia contents becomes enormous, there exists a desire for an automated system allowing a selection of data desired by users, and, accordingly, studies of solutions for meeting such a desire have been briskly progressed.

Particularly, news video of the multimedia contents is a field in which users take much interest and is presently being broadcasted every day.

The news video has mostly a fixed structure regardless of time and space. Accordingly, in the early stage of video indexing, studies of the indexing of news video have been made, and it is presently known that it is possible to accomplish article division techniques for the news video.

As a fast browsing technique for the news video, an interface using key frames or an article summary system using key frames has been proposed. The fast browsing technique can divide the news video by the article unit, represent concerned articles as several key frame, and select articles desired by a user to browse the selected articles.

However, such an interface or an article summary system allows the user to view the desired articles only by selecting them after manually navigating the articles. Therefore, for minimization of input required to the user by automatically recommending and showing the user only articles in which he takes an interest, the interface or article summary system using the key frames is not proper.

FIG. 1 shows a schematic view of a structure of a general news video.

Referring to FIG. 1, the news video typically includes headline news sections, detail news sections, summary news sections, intermediate-inserted commercial advertisements, etc. The detail news sections can be divided for each news item (i.e., article). Each news item is basically divided into an anchor scene in which a news anchorman briefs the summary of article and an episode scene or reporter scene in which the news anchorman announces the contents of news in detail.

The article can be detected by using the typical structure of news video as described above, which will be described below.

A typical news video indexing system detects shots as a video edition unit in the news video and then models a characteristic of anchor scene of each of the shots, or detects anchor scenes using an anchor scene template and then detects an article on the basis of each of the anchor scenes.

In addition, if necessary, advertisement portions are separately detected and indexed by using an advertisement detection algorithm, and headline portions or summary news portions are separately detected and indexed by using their characteristics.

On the other hand, a more advanced news video indexing system provides semantic information by indexing which of politics, sports, economics and the like is included in a concerned news article, or by indexing a main person in the concerned news, in combination with technologies of closed caption or audio process, face detection, face recognition and so on.

FIG. 2 is a view for illustrating a conventional article news video browsing system.

Referring to FIG. 2, the system detects an anchor scene, indexes article information on the basis of the detected anchor scene, and indicates a plurality of key frames as a representative of a concerned article. A user can browse news by the unit of article using the plurality of key frames.

FIG. 3 shows a view explaining a concept of video skimming for accomplishing an effect similar to highlights by continuously providing a user with only a specific portion capable of representing the contents of concerned scenes or shots by analyzing the structure of video contents.

The video skimming is a general method for separating segments to be reproduced and segments to be skipped and successively reproducing the segments to be reproduced with no time delay. As a method for reproducing each of the segments, a reproduction method using a normal reproduction mode or a fast viewing function can be used.

Such a video skimming is utilized as a method for allowing a user to understand a gist of the video contents in short time.

However, conventional methods of article-based video browsing or video skimming have disadvantages that they need a number of user inputs and they can not efficiently providing a great deal of information in limited period of time. So, those methods are not appropriate for implementing an automated or intelligent video browsing system.

### SUMMARY OF THE INVENTION

In considerations of the above circumstances, an object of the present invention is to provide an adaptive news video skimming system using characteristics of the news video, particularly, structural information on the news video and the semantic information on scenes and shots of the news video.

Another object of the present invention is to provide an intelligent news video browsing system which allows a user to grasp the whole content of video news within limited time in a digital video environment or allows a user to move to desired positions in the news video by a request by the user, and automatically reflects preference/non-preference of the user.

Still another object of the present invention is to provide an intelligent news video browsing system using structural information on news video contents including not only shot segmentation information but also scene information divided into articles.

Still another object of the present invention is to provide an intelligent news video browsing system which automatically reflects not only viewing preference of general users but also preference/non-preference of an individual user of the user.

Still another object of the present invention is to provide a news video browsing system including a news video skimming function for efficiently delivering a great deal of information in short time on the basis of shot segmentation and news video indexing technology based on clustering.

To achieve these objects, according to an aspect of the present invention, a news video browsing method comprises the steps of: producing index information on anchor shot segment and episode scene segment in news video contents including at least both of the segments; and browsing a concerned news video by applying different reproduction methods and different reproduction speeds to each of the anchor shot segment and episode scene segment in the news video contents.

According to another aspect of the present invention, a news video browsing method comprises the steps of: producing index information on summary news segment, and advertisement segment intervening between pieces of news in news video contents including at least both of the segments; and browsing a concerned news video by applying different reproduction methods and different reproduction speeds to each of the summary news segment and the advertisement segment in the news video contents.

According to still another aspect of the present invention, a news video browsing method comprises the steps of: producing genre information on news article and user profile information on individual users in news video contents including at least news article segment; and browsing a concerned news video by applying different reproduction method and different reproduction speeds to each of concerned news articles on the basis of the user profile information.

According to still another aspect of the present invention, a news video browsing apparatus comprises an index information providing means for providing structural/semantic index information on each of segments in news video contents; a media storage means for storing the news video contents; a user interface means for interfacing the user with a browsing system; a reproduction control parameter storage means for storing information on a reproduction method and a reproduction speed for each of the segments including the index information; a control means for controlling the reproduction method and the reproduction speed of news segment identified by corresponding index information on the basis of the structural/semantic index information, when media files in said media storage means are reproduced upon request by user inputted through said user interface means; and a display means for reproducing and then displaying the news video contents under a control of said control means.

By the method and the apparatus as described above, the user can browse news more conveniently.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view of a structure of a general news video;

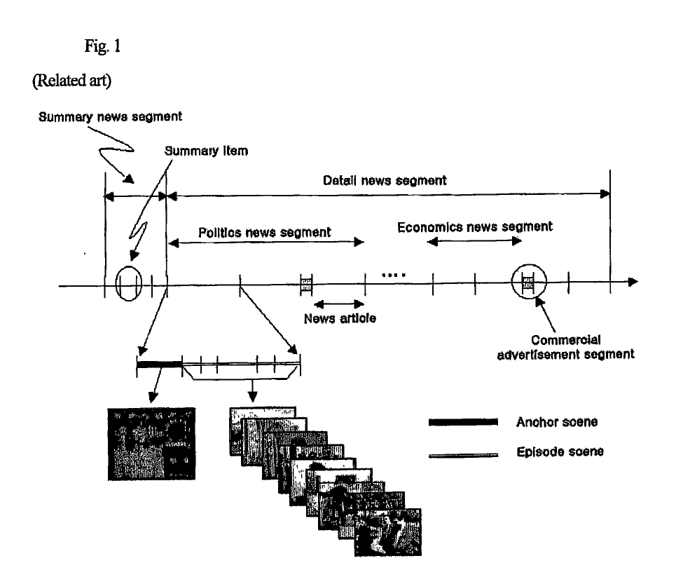

FIG. 2 is a view for illustrating a conventional article news video browsing system.

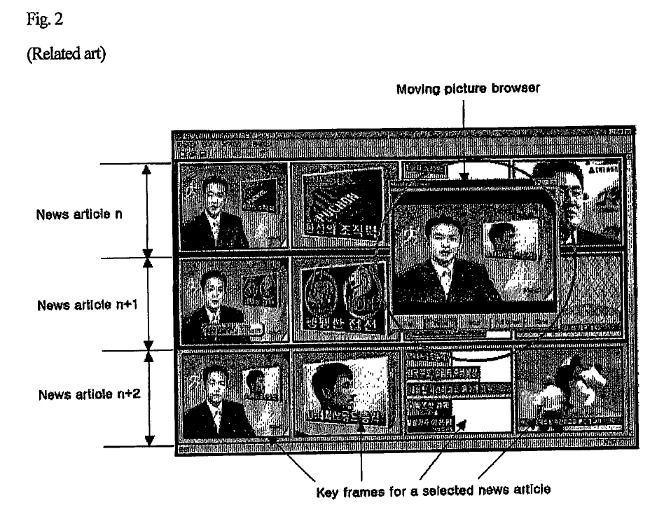

FIG. 3 is a view explaining a concept of video skimming;

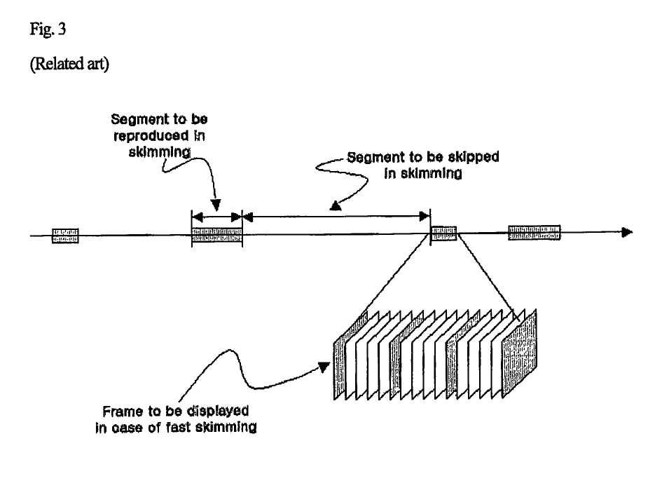

FIG. 4 is a view for illustrating an example of a structure of an intelligent news video indexing system;

FIG. 5 is a view for illustrating a first embodiment of an intelligent news video browsing method according to the present invention;

FIG. 6 is a view for illustrating a second embodiment of an intelligent news video browsing method according to the present invention;

FIG. 7 is a view for illustrating a third embodiment of an intelligent news video browsing method according to the present invention;

FIG. 8 is a view showing an example of preference/non-preference expression of a user in the present invention;

FIG. 9 is a view for illustrating a first embodiment of an intelligent news video browsing system according to the present invention;

FIG. 10 is a view for illustrating a second embodiment of an intelligent news video browsing system according to the present invention.

### DETAILED DESCRIPTION OF THE INVENTION

Preferred embodiment of the present invention will now be described in detail with reference to the accompanying drawings, in which the same reference numerals are used throughout the different drawings to designate the same or similar components.

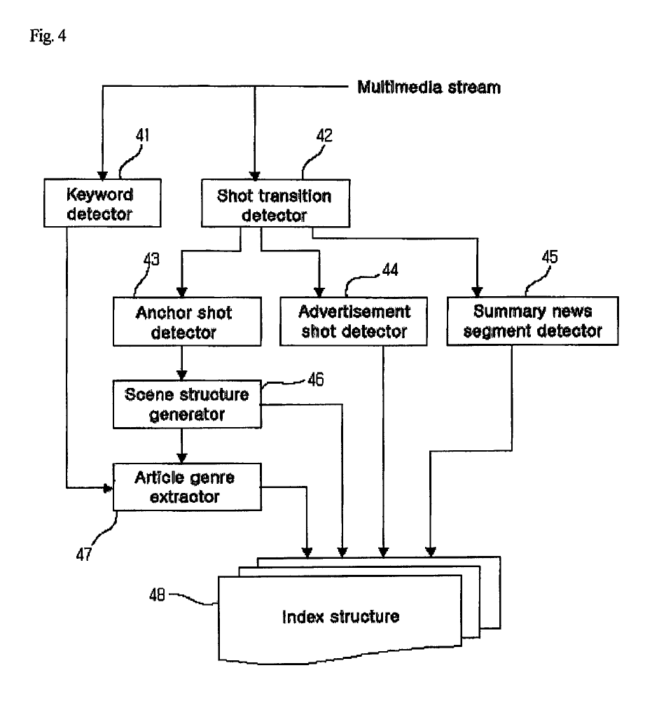

FIG. 4 is a view for illustrating an example of a structure of an intelligent news video indexing system.

Referring to FIG. 4, a news video indexing system of the present invention comprises a keyword detector 41 for detecting a key word from a multimedia stream (news video contents), a shot transition detector for detecting a shot transition of news video 42, an anchor shot detector 43 for detecting an anchor shot based on the shot transition detection information, an advertisement shot detector 44 for detecting a advertisement shot based on the shot transition detection information, a summary news segment detector 45 for detecting a summary news segment based on the shot transition detection information, a scene structure generator 46 for generating structural information on a concerned scene based on the anchor shot detection information, and an article genre extractor 47 for extracting a genre of an article based on the key word and the scene structure.

All of the information extracted by the elements as described above is used for the generation of an index structure 48.

The news video indexing system can be an automatic system or a semiautomatic system. This news video indexing system can be implemented in a system equivalent to an intelligent news video browsing system, or can be designed as an independent system connected to other systems through communication networks.

The smallest news video indexing system required for intelligent news video browsing according to the present invention is a system that is capable of distinguishing the segmentation by article from the anchor shot and the episode scene. Therefore, this indexing system requires a shot segmentation module and an anchor shot detection module. In addition, this indexing system can further include a summary news segment detection module, a key word detection module for extracting a key word from a closed caption or audio, an article genre determination module for determining whether a concerned news article is news related to politics, news related to economics, or news related to sports, a commercial advertisement segment detection module, etc.

Such a news video indexing system extracts a structured news video index, with a video stream as an input

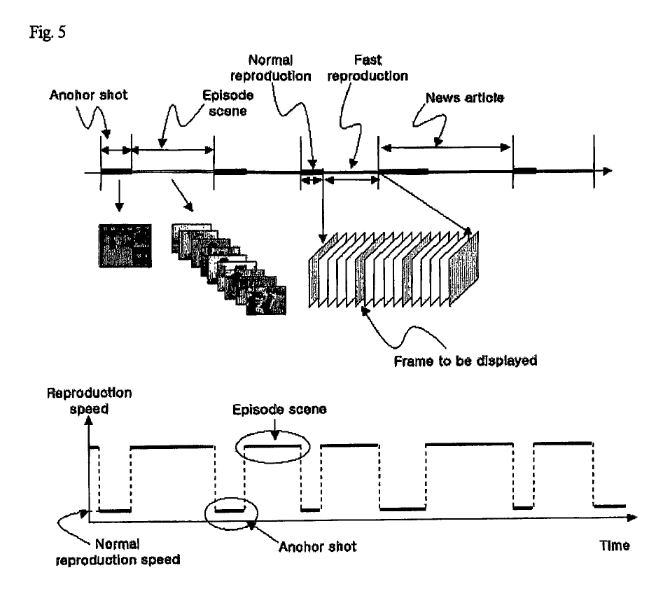

FIG. 5 is a view for illustrating a first embodiment of an intelligent news video browsing method according to the present invention.

In the first embodiment of the browsing method of the present invention as shown in FIG. 5, a reproduction method in the intelligent news video browsing system using the segmentation by article and the index information by which the anchor shot and the episode scene are indexed is schematized. The first embodiment proposes the intelligent news video browsing method in which different skimming method are applied to each of the anchor shot and the episode scene.

More particularly, the first embodiment allows a great deal of contents to be delivered in shorter time by distinguishing the anchor shot to summarize and deliver the content of a piece of news article from the episode scene to fully explain the news article and applying different reproduction methods and different methods to select segments to be reproduced to each of the anchor shot and the episode scene. As a reproduction method in the present invention, other individually applicable reproduction speeds can be used.

In general, since the anchor shot summarizes the whole news content, an audio is a very important part. For this reason, the anchor shot is reproduced by using a normal reproduction method, and the episode scene is reproduced by employing a skimming method using a skipping and fast view function since it is less important than the anchor shot.

As described above, the method for reproducing specific segments of the news video can use a method for increasing the number of frames to be decoded by the unit of time or even a skipping method.

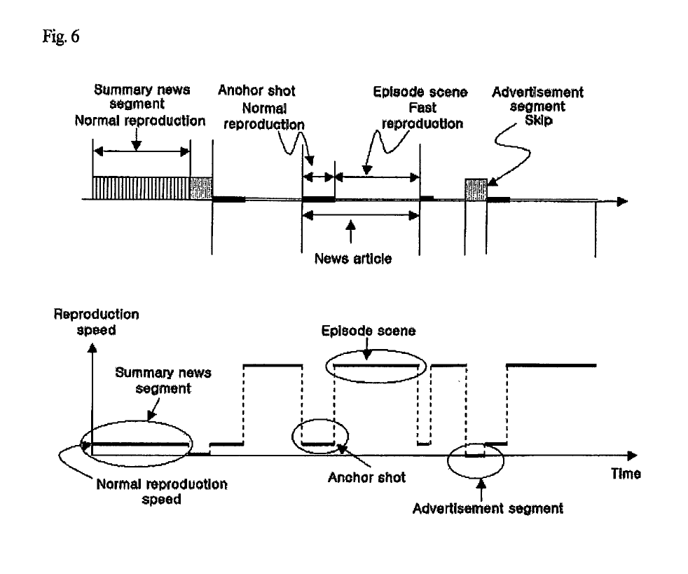

FIG. 6 is a view for illustrating a second embodiment of an intelligent news video browsing method according to the present invention.

Referring to FIG. 6, the second embodiment proposes a reproduction method in the intelligent news video browsing system in case that the news video includes first semantic information including information on a summary news segment, index information on a commercial advertisement segment, etc., in addition to segmentations by article and index information by which the anchor shot and the episode scene are indexed.

In general, since the summary news segment is a segment for introducing main news in the whole news contents, it should be reproduced in the normal speed, like the anchor shot reproduction, so that its semantic content can be fully delivered. Therefore, since it is preferable that the summary news segment is not skipped, it is preferable that the normal reproduction including the audio reproduction is performed.

However, since the commercial advertisement segment is a segment that most of users do not want to view, it is preferable to be skipped. Merely, upon requests by users, a method for increasing the number of frames to be decoded by the unit of time or a skipping method is applicable in order to increase the reproduction speed so that it is possible to view the commercial advertisement segment quickly.

The summary news segment in the news video contents is a segment positioned in an front portion, a rear portion, or an intermediate portion of the news video for providing a brief summary of an important news article among the whole news article, and the advertisement segment is a segment positioned in an intermediate portion for providing a commercial advertisement in the news video.

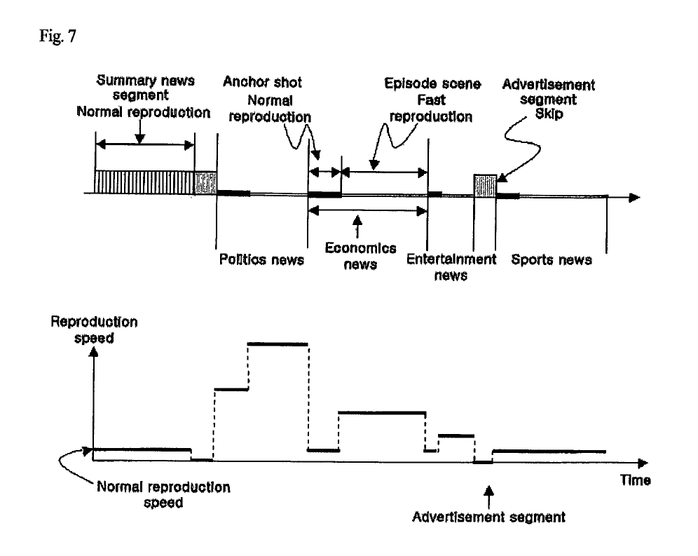

FIG. 7 is a view for illustrating a third embodiment of an intelligent news video browsing method according to the present invention.

Referring to FIG. 7, the third embodiment proposes a reproduction method in the intelligent news video browsing system in case that the news video includes second semantic information including article genre information on a news article and preference/non-preference information as user profile information provided from a storage device such as a smart card or a nonvolatile memory connected to a remote site, in addition to segmentations by article and index information by which the anchor shot and the episode scene are indexed.

Watching pattern for news video is different from a user to another. That is, article genre preferred and not preferred are different from a user to another. For example, some users can have an interest in politics news while having no interest in economics news. Such a preference/non-preference can be not only for the article genre but also for a specific person or for kinds of sports.

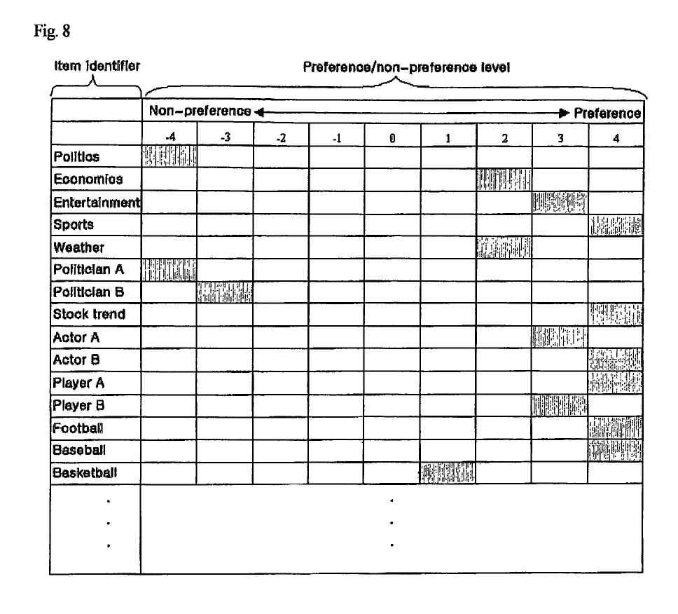

FIG. 8 is a view showing an example of preference/non-preference expression of a user.

In FIG. 8, a user's preference/non-preference for each item is indicated as negative and positive numbers. A positive number with a larger absolute value means a higher preference and a negative number with a larger absolute value means a higher non-preference. Such a user's preference/non-preference can be directly set by the user, or can be set by automatically analyzing an access pattern of the user. Information on user's preference/non-preference can be stored in a storage device in order to reflect a request by the user at all times. Such a storage device can be a nonvolatile memory or a portable smart card, or can be directly connected to the browsing system. Alternatively, the information on user's preference/non-preference can be stored at a remote site when the user can access a server of the remote site, as in a case that the index information is delivered through communication networks.

In addition, the user profile information can include information on reproduction speed and reproduction method for each article genre in addition to the information on the user's preference/non-preference for each article genre.

The above-described third embodiment of the browsing method of the present invention proposes a news video browsing system reflecting the preference/non-preference.

More particularly, when the genre information on the news article and the user's preference/non-preference are provided together, the browsing system reproduces a concerned news article for an article genre preferred by the user by using a reproduction method by which the meaning of the article genre can be sufficiently understood (herein, the normal speed reproduction method), but skips or quickly reproduces genres other than the article genre preferred by the user. This concept is to reproduce the whole news video in a way that weight value for each news article is differently set in consideration of the user's preference/non-preference such that the reproduction method by which the meaning of the article genre can be sufficiently understood is selected for news articles with high weight (i.e., high preference) and a skipping or fast reproduction method is selected for news articles with low weight (i.e., low preference/high non-preference).

The third embodiment is to propose a method for adaptively selecting different reproduction speeds for summary news segment, politics news segment, economics news segment, entertainment news segment, advertisement segment, anchor shot, etc., and browsing these segments.

Referring to FIG. 7 again, the politics news articles with low preference are most quickly reproduced, the summary news section and sports news section are normally reproduced, and the advertisement section is not reproduced.

On the other hand, the reproduction for each news segment can be freely set by the user and can be set for every kind of news in the browsing system.

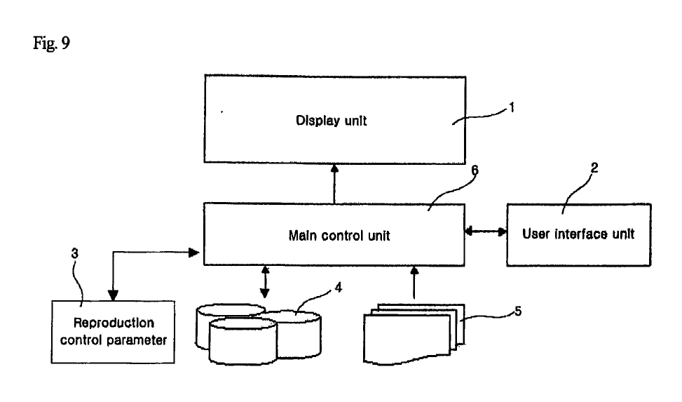

FIG. 9 is a view for illustrating a first embodiment of an intelligent news video browsing system according to the present invention;

Referring to FIG. 9, a display unit 1 is an output device for reproducing media files, a user interface unit 2 is an input device such as a key board, a mouse, a remote controller, etc., and a reproduction control parameter storage unit 3 is a nonvolatile memory for storing parameters of reproduction control related to a basic reproduction method, reproduction speed, etc. Particularly, the reproduction control parameter storage unit 3 can store information on different reproduction methods and speeds for anchor segment, episode segment, summary news segment, and advertisement segment in the news video.

In addition, a media file unit 4 is a storage device for storing actual media files and an index file unit 5 is a storage device for storing indexes of multimedia contents. Particularly, the media file unit 4 and the index file unit 5 can be unified in the browsing system, or when the intelligent news video browsing system is implemented in a client device under client-server environments, the media file unit 4 and the index file unit 5 can be incorporated into a server device such that the media and index information can be provided through communication networks established between the client device and the server device.

In the index file unit 5, segmentation by article for the news video stored in the media file unit 4 and information on whether a concerned segment is an anchor shot or an episode shot are basically indexed. In addition, first semantic information (information on the summary news segment, index information on the commercial advertisement segment, etc.) can be added in the news section.

In other words, the index file unit 5 can have structural/semantic index information for each segment of the news video, including information indexed by time information on the anchor segment and the episode segment in the news article section, information indexed by time information on the summary news segment, information indexed by time information on the commercial advertisement segment, etc.

In addition, a main control unit 6 outputs a concerned news video to the display unit 1 upon request by the user by using the index information, the first semantic information, the reproduction control parameter, etc.

Now, the operation of the first embodiment of the news video skimming system according to the present invention will be explained.

When the user requests an intelligent browsing function for the news video by using the user interface unit 2, the main control unit 6 of the system determines the reproduction method and the reproduction speed for each segment on the basis of a current reproduction position by using the index related to information on segment by article, information on anchor shot and information on episode scene in the index file unit 5, and, accordingly, reproduces a concerned news video stream within the media file unit 4 and outputs it to the display unit 1. In addition, the user can directly set this reproduction method and the reproduction speed, or if necessary, can use a basic value already set in the system.

Since the reproduction control parameter storage unit 3 stores information on which reproduction method is to be used depending on what kind of segment a concerned segment is, conclusively the skimming system can determine the reproduction method by determining whether segment to be reproduced is an anchor shot or an episode shot, and apply different reproduction methods and different reproduction speeds to the summary news segment and the commercial advertisement segment in case that the first semantic information is additionally provided.

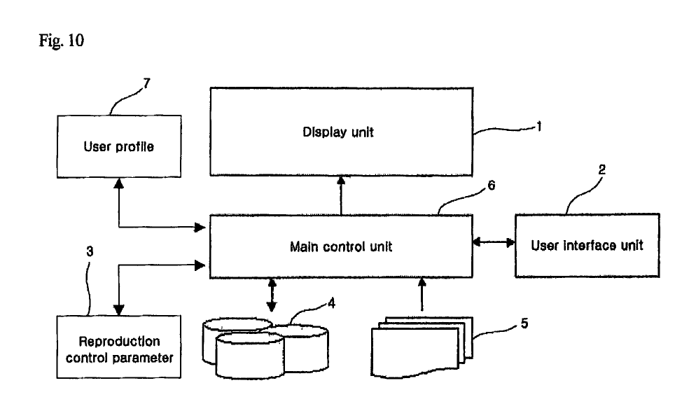

FIG. 10 is a view for illustrating a second embodiment of an intelligent news video browsing system according to the present invention.

For the convenience of explanation, in FIG. 10, same reference numerals are designated to same elements as in the first embodiment of the intelligent news video skimming system shown in FIG. 9, and the description thereof shall be omitted here.

In the second embodiment of the news video skimming system of the present invention, segmentation by article for the news video stored in the media file unit and information on whether a concerned segment is an anchor shot or an episode shot are basically indexed in the index file unit 5. In addition, first semantic information (information on the summary news segment, index information on the commercial advertisement segment, etc.) and second semantic information (the article genre information on the news article) are together provided for each news section.

A user profile unit 7 includes information on the user's preference/non-preference. In addition, a basic value set by the user for the reproduction method and the reproduction speed according to each segment characteristic can be recorded in the user profile unit 7. The user profile unit 7 can be a nonvolatile memory incorporated into the system or a portable medium such as a smart card, as described earlier. In addition, in case that such information and basic value are stored in a nonvolatile memory at a remote site, they can also be stored in the nonvolatile memory incorporated into the system.

The operation of the news video skimming system of FIG. 10 is similar to that of the system of the first embodiment of FIG. 9 as described earlier.

When the user requests an intelligent browsing function for the news video by using the user interface unit 2, the main control unit 6 of the system determines the reproduction method and the reproduction speed for each segment on the basis of a current reproduction position by using the index related to information on segment by article, information on anchor shot, information on episode scene, summary news segment, advertisement segment, etc. in the index file unit 5, and, accordingly, reproduces media file and outputs it to the display unit 1.

In addition, the user can directly set this reproduction method and the reproduction speed, or if necessary, can use a basic value already set in the system. Since the reproduction control parameter storage unit 3 stores information on which reproduction method is to be used depending on what kind of segment a concerned segment is, conclusively the skimming system can determine the reproduction method by determining whether segment to be reproduced is an anchor shot or an episode shot, and apply different reproduction methods and different reproduction speeds to the summary news segment and the commercial advertisement segment in case that the first semantic information is additionally provided.

Unlike the video skimming system using the existing structural information, the present invention provides the intelligent news video browsing system which is capable of efficiently delivering a great deal of information in short time by applying different reproduction methods to each segment by separating the anchor shot and the episode scene which are extractible from the news video indexing system.

In addition, the present invention provides the intelligent news video browsing system which is capable of efficiently delivering a great deal of information in short time by setting different importance weights to each of the summary news segment, the detail news segment, the advertisement segment, etc.

In addition, the present invention can deliver information adaptively in accordance with the user preference by the article genre information and the user preference/non-preference information.

In addition, the present invention can reproduce portions desired by the user while skipping portions not desired by the user by using the functions of pause, instant replay, forward skip, etc. at any time during the intelligent news video reproduction.

In addition, the present invention provides the intelligent news video browsing system which is capable of browsing the news video in short time with a minimal user input and without missing the semantic content of the news video.

Furthermore, the present invention can be implemented in a client system under client-server environments or can be also implemented in a set-top box such as a PVR (personal video recorder).

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An intelligent news video browsing method comprising the steps of:
producing index information on anchor shot segment and episode scene segment in news video contents including at least both of the segments; and
browsing a concerned news video by applying different reproduction methods and different reproduction speeds to each of the anchor shot segment and episode scene segment in the news video contents.

2. The intelligent news video browsing method according to claim 1, wherein the anchor shot segment is reproduced by a normal reproduction method including an audio reproduction and a normal reproduction speed.

3. The intelligent news video browsing method according to claim 1, wherein the episode scene segment is reproduced in a speed faster than the normal reproduction speed by using a method which increases the number of frames to be decoded per the unit of time and/or a skipping method.

4. An intelligent news video browsing method comprising the steps of:
producing index information on summary news segment, and advertisement segment intervening between pieces of news in news video contents including at least both of the segments; and
browsing a concerned news video by applying different reproduction methods and different reproduction speeds to each of the summary news segment and the advertisement segment in the news video contents.

5. The intelligent news video browsing method according to claim 4, wherein the summary news segment is reproduced by a normal reproduction method including an audio reproduction and a normal reproduction speed.

6. The intelligent news video browsing method according to claim 4, wherein the advertisement segment is skipped.

7. The intelligent news video browsing method according to claim 4, wherein the advertisement segment is reproduced in a speed faster than the normal reproduction speed by using a method which increases the number of frames to be decoded per the unit of time and/or a skipping method.

8. An intelligent news video browsing method comprising the steps of:
producing genre information on news article and user profile information on individual users in news video contents including at least news article segment; and
browsing a concerned news video by applying different reproduction methods and different reproduction speeds to each of concerned news articles on the basis of the user profile information.

9. The news video browsing method according to claim 8, wherein the user profile information includes at least one of user preference, user non-preference, user preference/non-preference, reproduction speed and reproduction method for genres of each article.

10. The news video browsing method according to claim 8, wherein the user profile information includes user preference for the genre of the news article, and the lower the preference is, the faster the reproduction speed is.

11. An intelligent news video browsing apparatus comprising;
an index information providing means for providing structural/semantic index information on each of segments in news video contents;
a media storage means for storing the news video contents;
a user interface means for interfacing the user with a browsing system;
a reproduction control parameter storage means for storing information on a reproduction method and a reproduction speed for each of the segments including the index information;
a control means for controlling the reproduction method and the reproduction speed of news segment identified by corresponding index information on the basis of the structural/semantic index information when media files in said media storage means are reproduced upon a request by user inputted through said user interface means; and
a display means for reproducing and then displaying the news video contents under a control of said control means.

12. The intelligent news video browsing apparatus according to claim 11, further comprises a user profile information storage means for storing information on the user and providing information on a specific user to said control means.

13. The intelligent news video browsing apparatus according to claim 12, wherein the user profile information includes preference/non-preference information on semantic segmentation of news article, wherein the reproduction method and reproduction speed are set in consideration of the preference/non-preference information.

14. The intelligent news video browsing apparatus according to claim 12, wherein the user profile information includes reproduction method information and reproduction speed information on semantic segmentation of news article.

15. The intelligent news video browsing apparatus according to claim 12, wherein said user profile information storage means is a nonvolatile memory attachable to the apparatus.

16. The intelligent news video browsing apparatus according to claim 12, wherein said user profile information storage means is a nonvolatile memory at a remote site.

17. The intelligent news video browsing apparatus according to claim 12, wherein said user profile information storage means is a potable storage device.

18. The intelligent news video browsing apparatus according to claim 12, wherein said index information providing means includes genre information of news article therein.

19. The intelligent news video browsing apparatus according to claim 11, wherein the structural/semantic index information on each of segments in news video contents is index information for more than one segmentation between anchor shot segment, episode scene segment, summary news segment, and advertisement segment.

20. The intelligent news video browsing apparatus according to claim 11, wherein under a client-server environment, said media storage means and said index information providing means are located at the server and provide concerned information to the client through a communication network.
